(19) United States
(12) Patent Application Publication
(10) Pub. No.: US 2023/0104122 A1
(43) Pub. Date: Apr. 6, 2023

(54) FACILITATING ACHIEVEMENT OF EQUILIBRIUM BETWEEN SUPPLY AND DEMAND OF RESOURCES

(71) Applicant: AT&T Intellectual Property I, L.P., Atlanta, GA (US)

(72) Inventors: Vladimir Sevastyanov, Fort Worth, TX (US); Abhay Dabholkar, Allen, TX (US); Abhishek Mishra, Richardson, TX (US); Nikhlesh Agrawal, McKinney, TX (US)

(21) Appl. No.: 17/494,211

(22) Filed: Oct. 5, 2021

(51) Int. Cl. G06Q 10/06

(52) U.S. Cl. CPC G06Q 10/0631; G06Q 10/0637

(57) ABSTRACT

Facilitating achievement of equilibrium between supply and demand of resources is provided herein. Operations of a system include determining a first amount of resources that are to satisfy first requests in a first area, and a second amount of resources that are to satisfy second requests in a second area and comparing the first amount of resources with a first quantity of available resources in the first area, and the second amount of resources with a second quantity of available resources in the second area. Further, based on the first quantity of available resources being less than the first amount of resources and the second quantity of available resources being more than the second amount of resources: classifying the first area as an overloaded condition, classifying the second area as an underloaded condition, and moving a resource of the second quantity of available resources to the first area.

### TECHNICAL FIELD

This disclosure relates generally to the field of load balancing and, more specifically, to facilitating achievement of equilibrium between supply and demand of resources.

### BACKGROUND

Routing of resources is a common task in many industries. Scheduling of resources to meet demand for the resources uses software to automate the process of creating and maintaining a schedule. Automating the scheduling of resources increases productivity and allows organizations to re-allocate resources to non-scheduling activities. Existing software automated rostering solutions are based on optimization algorithms such as stochastic optimization, genetic algorithms, colony optimization, simulated annealing, quantum annealing Tabu search, and coordinate descent. Such optimization tasks have NP-hard complexity. Accordingly, unique challenges exist associated with scheduling resources without the complexity experienced by existing techniques.

### BRIEF DESCRIPTION OF THE DRAWINGS

Various non-limiting embodiments are further described with reference to the accompanying drawings in which:

FIG. 1 illustrates an example, non-limiting, computer-implemented method for facilitating load balancing of various resources in accordance with one or more embodiments described herein;

FIG. 2 illustrates an example, non-limiting, table for determining movement of resources for load balancing in accordance with one or more embodiments described herein;

FIG. 3 illustrates an example, non-limiting, representation of an implementation that uses geographic locations of a geographic map for equalizing resources associated with customer service in a telecom industry in accordance with one or more embodiments described herein;

FIG. 4 illustrates an example, non-limiting, representation of an implementation that uses geographic locations for facilitating delivery of items in accordance with one or more embodiments described herein;

FIG. 5 illustrates an example, non-limiting, schematic representation for an implementation for rostering nurses in a hospital in accordance with one or more embodiments described herein;

FIG. 6 illustrates an example, non-limiting, computer-implemented method for facilitating achievement of equilibrium between supply and demand of resources in accordance with one or more embodiments described herein;

FIG. 7 illustrates an example, non-limiting, computer-implemented method for load balancing resources in accordance with one or more embodiments described herein;

FIG. 8 illustrates an example, non-limiting, system that facilitates achieving stable equilibrium between supply and demand of resources in accordance with one or more embodiments described herein;

FIG. 9 illustrates an example, non-limiting, block diagram of a handset operable to engage in a system architecture that facilitates wireless communications according to one or more embodiments described herein; and

FIG. 10 illustrates an example, non-limiting, block diagram of a computer operable to engage in a system architecture that facilitates wireless communications according to one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details (and without applying to any particular networked environment or standard).

Described herein are systems, methods, articles of manufacture, and other embodiments or implementations that can facilitate achieving equilibrium between supply and demand of resources. More specifically, the disclosed embodiments are intended to facilitate equilibrium between demand and supply.

By way of example and not limitation, the resources discussed herein can be any resources that are requested. Some examples refer to technicians (e.g., service technicians), post office employees, nurses in a health care facility, and/or pilots in an airline situation. However, the disclosed embodiments are not limited to human actors. Instead, the disclosed embodiments can be utilized in various situations for which equilibrium between supply and demand of resources is desired. Such resources can include, but are not limited to, resources that can be reusable (e.g., aircraft, vehicles, medical equipment, testing equipment, other equipment, and so on).

An embodiment relates to a method that includes dividing, by a system comprising a processor, a defined area into a group of sub-areas. The method also includes determining, by the system, respective quantities of resources scheduled to be deployed in sub-areas of the group of sub-areas based on received requests. Respective differences between available resources in the sub-areas and the respective quantities of resources to be deployed in the sub-areas are also determined. The method also includes classifying, by the system, the sub-areas as a function of the respective differences and deploying, by the system, the available resources among the sub-areas based on the classifying.

According to some implementations, the classifying includes respectively classifying respective sub-areas of the sub-areas as one of: a first subset comprising an underloaded condition, a second subset comprising an overloaded condition, and a third subset comprising an equilibrium condition. Further to these implementations, a first sub-area of the sub-areas is classified as being in the underloaded condition, a second sub-area of the sub-areas is classified as being in the overloaded condition, and the deploying comprises moving a resource from the first sub-area to the second sub-area. Further, in some implementations, moving of the resource includes reducing an imbalance between the received requests and the respective quantities of resources scheduled to be deployed in the sub-areas. In an example, a third sub-area of the sub-areas is classified as being in the equilibrium condition, and the method further includes marking, by the system, the third subset in the equilibrium condition as unchangeable.

Deploying the available resources among the sub-areas can include, according to some implementations, load balancing the available resources among the sub-areas.

According to some implementations, prior to the determining of the respective differences, the method can include identifying, by the system, a defined time (e.g., duration) in which the received requests are to be satisfied.

According to some implementations, the method can include determining, by the system, that a sub-area of the sub-areas has a higher quantity of resources scheduled to be deployed in the sub-area based on an analysis of the received requests. Further to these implementations, the method can include identifying, by the system, the sub-area as being in an underloaded condition.

The method can include, in some implementations, determining, by the system, that a sub-area of the sub-areas has a lower quantity of resources scheduled to be deployed in the sub-area based on an analysis of the received requests. Further to these implementations, the method can include identifying, by the system, the sub-area as being in an overloaded condition.

In accordance with some implementations, the method can include, prior to the determining of the respective quantities of resources, receiving, by the system, input data indicative of constraints related to respective availabilities of resources.

Another embodiment relates to a system that can include a processor and a memory that stores executable instructions that, when executed by the processor, facilitate performance of operations. The operations can include determining a first amount of resources that are to satisfy first requests in a first area, and a second amount of resources that are to satisfy second requests in a second area. The operations also can include comparing the first amount of resources with a first quantity of available resources in the first area, and the second amount of resources with a second quantity of available resources in the second area. Further, the operations can include, based on the first quantity of available resources being determined to be less than the first amount of resources and the second quantity of available resources being determined to be more than the second amount of resources: classifying the first area as being in an overloaded condition, classifying the second area as being in an underloaded condition, and moving a resource of the second quantity of available resources to the first area.

According to some implementations, the operations can include, based on the first quantity of available resources being more than the first amount of resources, and the second quantity of available resources being equal or nearly equal to the second amount of resources: classifying the first area as being in the underloaded condition, classifying the second area as being in an equilibrium condition, and identifying the second quantity of available resources as unchangeable resources, wherein the first area remains classified as being in the underloaded condition.

In an example, moving of the resource can include facilitating load balancing of resources between the first area and the second area. Further to this example, the resources comprise the first quantity of available resources and the second quantity of available resources.

According to some implementations, the operations include, prior to the determining of the first amount of resources, receiving input data that comprises first information indicative of the first area, second information indicative of the second area, third information indicative of an amount of resource requests, fourth information indicative of the first quantity of available resources in the first area, and fifth information indicative of the second quantity of available resources in the second area.

The operations can also include, in some implementations, prior to the determining of the first amount of resources, receiving input data indicative of constraints related to the first quantity of available resources in the first area and the second quantity of available resources in the second area. Further to these implementations, the constraints can be based on travel time between the first requests in the first area and the second requests in the second area.

Another embodiment relates to a non-transitory machine-readable medium, comprising executable instructions that, when executed by a processor, facilitate performance of operations. The operations can include dividing a service area into three subsets of areas. The three subsets of areas include a first subset as being in an underloaded condition, a second subset as being in an overloaded condition, and a third subset as being in an equilibrium condition. The operations also include adding first resources of the first subset to second resources of the second subset and retaining third resources of the third subset within the third subset.

In some implementations, dividing the search area into three subsets of areas can include determining that first requests in the first subset are less than a first amount of first resources available in the first subset. The dividing can also include determining that second requests in the second subset are more than a second amount of second resources available in the second subset. Further, the dividing can include determining third requests in the third subset are equal to a third amount of third resources available in the third subset.

In an implementation, adding first resources to second resources can include initiating a load balancing of resources in the first subset and the second subset. In further implementations, adding first resources to second resources can include reclassifying the first subset and the second subset as being in the equilibrium condition.

According to an example, non-limiting, implementation, the telecom industry provides technical support to millions of customers over an entire geographic area (e.g., the territory of North America). The territory is split into a set of Routing Areas (RA) served by a single team of technicians. Routing areas are combined in an Area of Interest (AOI), which can include ten to fifteen routing areas, for example. The customers service requests in an RA can be referred to as “demand,” and all technicians available in the RA for performing required service can be referred to as “supply.” Each RA has a permanent number of technicians, but the number of service requests (demand) can be very different depending on day of week, holidays, seasonal factors, unpredictable outages, and so on. In order to balance demand and supply on a daily basis, technicians can be loaned from one RA to another. Keeping demand and supply in balance is a constant struggle. The consequences of poor customer service, high overtime, high travel time, and failure to meet planned business goals lead companies in search of a process to better manage the delicate balance of demand and supply.

Existing load balancing is performed based on combinatorial optimization processes on a daily basis for the current demand. The enormous number of combinatorial combinations causes a heavy computational effort, and do not allow for finding a global optimal solution. Optimization sessions can take a few hours to execute, and solutions found by such optimization techniques cause unnecessary overtime, long travel time, and an unreasonable number of technician loans. The disclosed embodiments facilitate finding the optimal solution analytically and can transfer the exact (or nearly exact) number of technicians from underloaded RAs to overloaded RAs to obtain equilibrium between demand and supply in a single computational step, which takes only a few seconds computations for a given AOI. Accordingly, with the disclosed embodiments, overall expenses for a given AOI can be significantly reduced while improving the quality of the service.

Further, the disclosed embodiments can determine if a given RA is underloaded or overloaded, and what number of technicians should be moved into each overloaded RA and moved out of each underloaded RA to satisfy equilibrium condition for a given AOI. Also, the various embodiments can determine RAs which initially satisfy the equilibrium condition. Such Ras (that already satisfy the equilibrium condition) should be excluded from the technician (or other resource) transferring process. Further, the disclosed embodiments improve the existing combinatorial optimization approach because the disclosed embodiments are based on a known (or determined) optimal solution and, thus, excludes the necessity to search for such optimal solution.

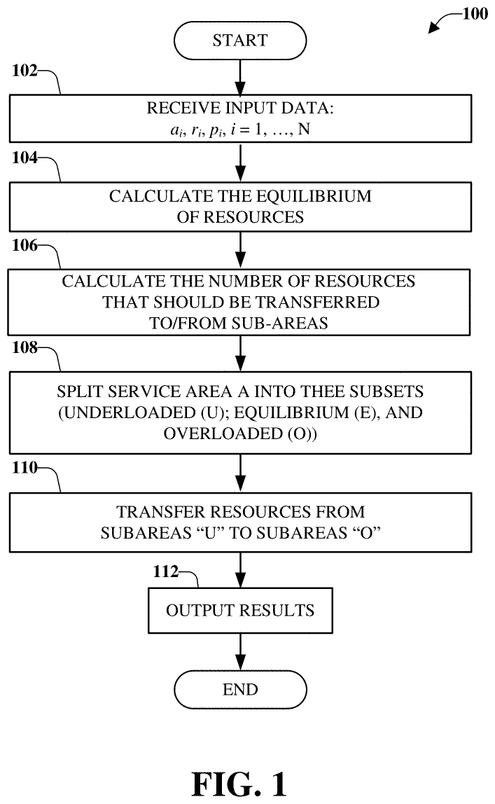

FIG. 1 illustrates an example, non-limiting, computer-implemented method 100 for facilitating load balancing of various resources in accordance with one or more embodiments described herein. The computer-implemented method 100 can be implemented by a system including a processor, network equipment including a processor, or another computer-implemented device including a processor.

The computer-implemented method 100 is configured to minimize and/or reduce disbalance between demand and supply of a variety of resources. For purposes of explanation, the computer-implemented method 100 will be discussed with respect to service entities of a telecom industry. However, as noted, the disclosed aspects are not limited to this implementation. Instead, other resources that are utilized to satisfy a demand for the resources can be configured in accordance with the various aspects discussed herein. Such resources include, but are not limited to, motorized vehicles, air craft, reusable products, reusable equipment, personnel, and so on.

As utilized herein, a requesting entity (e.g., requestor, service requestor) can request a certain resource, which is referred to as “demand.” A fulfillment entity (e.g., provider, service provider) can provide the certain resource requested by the requesting entity, which is referred to as “supply.” According to an example, the requesting entity can be a customer and the fulfillment entity can be a technician. In another example, the requesting entity can be a patient and the fulfillment entity can be a nurse. In yet another example, the requesting entity can request a self-driving vehicle for transportation of people and/or objects from a source location(s) to a destination location(s) and the fulfillment entity can be the self-driving vehicle (or an entity that manages one or more self-driving vehicles).

An area of interest (AOI) can be, for example, a service area (e.g., a communication network, a hospital, a location within a certain distance of a defined point, and so forth). The AOI can be divided into subareas, which are also referred to as service subareas (e.g., a routing area, a medical department, neighborhoods, and so forth). Further, a time interval can be defined (e.g., a service duration), which indicates the time during which the requests should be fulfilled.

There can be an initial allocation of requesting entities and fulfillment entities (e.g., requestors and providers). For example, a service area A has N sub-areas: a₁, a₂, . . . , a_{N}: A=∪ᵢ₌₁^{N}aᵢ. Each sub-area has: pᵢ service providers, rᵢ service requestors, and tᵢ sum of hours necessary to perform service to all requestors in sub-area i.

The number of Service Providers pᵢ in each sub-area aᵢ can be different each day due to, for example, vacations, day-off, scheduled maintenance, break-down of vehicles, and so on. The number of Service Requestors rᵢ in aᵢ is different for each day due to, for example, customer calls, service requests, and so forth.

The optimization objective of the disclosed embodiments is to:

$$Minimize {\sum }_{i = 1}^{N} {( \frac{{S}_{t}}{{S}_{p}} - \frac{{t}_{i}}{{p}_{i}} )}^{2} . \qquad Formula 1$$

where the sum of hours for Service Area A is:

$${S}_{t} = {\sum }_{i = 1}^{N} {t}_{i} . \qquad Formula 2$$

the sum of service providers for Service Area A is:

$${S}_{p} = {\sum }_{i = 1}^{N} {p}_{i} . \qquad Formula 3$$

and where the equilibrium condition for each sub-area aᵢ is:

$$\frac{{S}_{t}}{{S}_{p}} = \frac{{t}_{i}}{{p}_{i}} , i = 1 , … N . \qquad Formula 4$$

The objective is to match the equilibrium condition for each sub-area aᵢ. The required (equilibrium) number of service providers for each sub-area aᵢ is:

$${p}_{i}^{e q} = \frac{{S}_{p} {t}_{i}}{{S}_{t}} . \qquad Formula 5$$

where the number of service providers for transferring from/to sub-area aᵢ is:

δᵢ=pᵢ^{real}−pᵢ^{eq} Formula 6.

The threshold for splitting service area A into three sets is: δₜₕᵣₑₛ∈[0.5, 0.99]. When the real number of providers is bigger than required, results in underloaded sub-area aᵢ, has extra providers:

δᵢ>δₜₕᵣₑₛ Formula 7.

When the real number of providers is smaller than required, this results in overloaded sub-area aᵢ, needs additional providers:

δᵢ<−δₜₕᵣₑₛ Formula 8.

An equilibrium condition results when the real number of providers pᵢ is just enough to serve requesters rᵢ in sub-area aᵢ:

−δₜₕᵣₑₛ<δᵢ<δₜₕᵣₑₛ Formula 9.

In further detail, the computer-implemented method 100 starts, at 102, when input data is received. The input data can include, but is not limited to, information indicative of a subarea (aᵢ), information indicative of a number (or quantity) of demands (e.g., requesting entities, service requestors (rᵢ)), information indicative of a number (or quantity) of supplies (e.g., fulfillment entity, service provider (pᵢ)), where i=1, . . . , N.

The demand is determined by the number of service requests in each service sub-area aᵢ (number of customer calls, number of patients, and so on). The supply is determined by the number of service providers available in each sub-area aᵢ (nurses, technicians, or other reusable resources).

At 104, the equilibrium of service providers (pᵢ^{eq}, i=1, . . . , N) can be calculated using Formula 5. Further, at 106, the number of service providers (or other resources) that should be transferred to/from subareas is determined. For example, δᵢ=pᵢ^{real}−pᵢ^{eq}pᵢ^{eq} can be calculated using Formula 6.

At 108, the Service Area A is split into three subsets, which identify the condition using Formulas 7, 8, and 9. A first subset is an underloaded (U) condition, a second subset is an equilibrium (E) condition, and a third subset is an overloaded (O) condition. Providers can be transferred, at 110, from subareas identified as having the underloaded (U) condition to subareas identified as having the overloaded (O) condition. The results can be output, at 110, as output data, and the computer-implemented method 100 ends.

The goal is to move providers between sub-areas aᵢ in such a way that work volume in each sub-area would be as close as possible to average work volume in the entire service area A. Thus, the computer-implemented method 100 determines a set of underloaded subareas U and a set of overloaded subareas O, and moves providers from set U to set O.

Since equilibrium is considered around average ratio

$$\frac{{S}_{t}}{{S}_{p}} ,$$

there are three zones U, E, O in most cases, and therefore, providers are moved from U to O subareas. However, it is possible that δᵢ satisfies the equilibrium condition (Formula 9) for all subareas simultaneously. In this case the computer-implemented method 100 does not move providers between subareas at all because the equilibrium condition is satisfied initially.

It is noted that, according to some implementations, the input data can include information indicative of one or more constraints. For example, in some cases, managers want to consider preferences of employees, which requires the implementation of optimization constraints. The computer-implemented method 100 can facilitate the transfer of service providers from sub-area U to sub-area O sequentially, one after another. In this case, individual constraints for each service provider can be analyzed and a transfer variant which matches all the employee preferences can be determined.

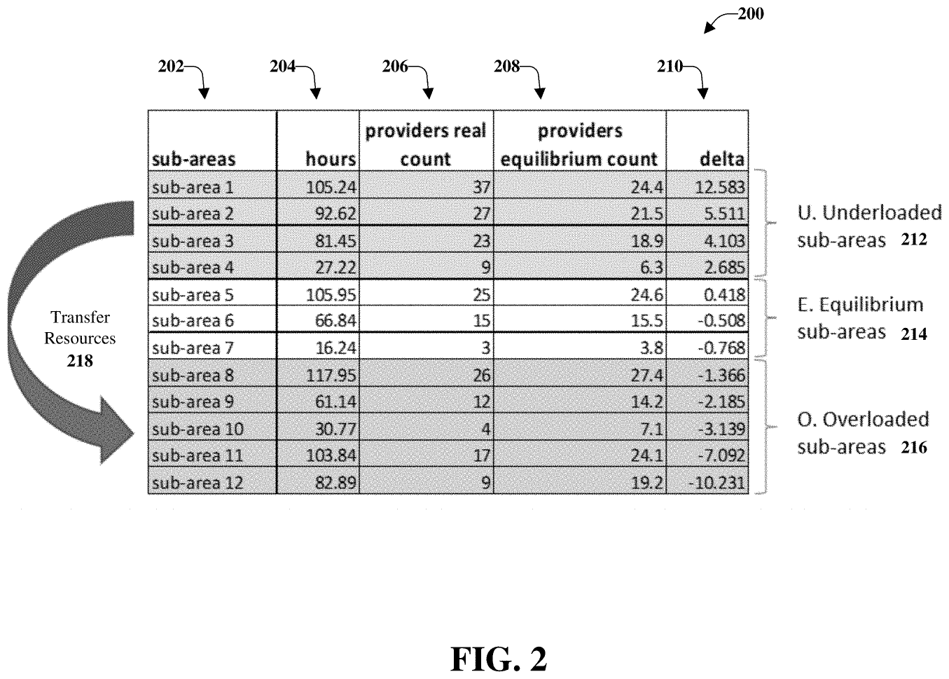

FIG. 2 illustrates an example, non-limiting, table 200 for determining movement of resources for load balancing in accordance with one or more embodiments described herein. The table 200 includes columns for sub-areas 202, hours 204, providers real count 206, providers equilibrium count 208, and delta 210. Although discussed with respect to providers, the disclosed embodiments can be utilized for any type of resource that is reusable and potentially available to fulfill requests for the resources.

The column for hours 204 includes the hours of required service for each sub-area. The column for providers real count 206 includes the number of service providers available for each sub-area. The column for providers equilibrium count 208 is calculated by Formula 5. The column for delta 210 is calculated by Formula 6. “Delta” shows the number of providers over equilibrium (δᵢ>δₜₕᵣₑₛ) or under equilibrium (δᵢ<−δₜₕᵣₑₛ), which allows for splitting or dividing service area A into a set of underloaded sub-areas U, a set of overloaded sub-areas O, and a set of equilibrium sub-areas E by using Formula 9.

The table 200 is illustrated as sorted by condition (U, E, or O) for purposes of explaining the disclosed embodiments. As depicted, in this example, the first four rows, indicated at 212, represent underloaded sub-areas (e.g., U condition). The next three rows, indicated at 214, represent equilibrium sub-areas (e.g., E condition). The remaining five rows, indicated at 216, represent overloaded sub-areas (e.g., O condition). Accordingly, as indicated by the arrow 218, providers (or other resources) are transferred from the underloaded sub-areas (212) to the overloaded sub-areas (216).

Existing approaches to solve the optimization task is to use optimization processes for minimization objective functions (such as Formula 1). Since domain of the function (e.g., Formula 1) is a discrete set (finite set of feasible solutions), combinatorial processes are used, which are NP-complete brute-force search processes. This means that computational effort grows exponentially with an increase to the number of discrete domain elements. Solving combinatorial optimization tasks can be based on heuristics allowing for the reduction of search volume.

The load balancer embodiments provided herein use a heuristic based on Formula 1, which is applicable to a wide class of optimization tasks. In particular, Formulas 1 through 6 allow for determination of the optimal solution analytically (see the table 200 of FIG. 2). In other words, use of the disclosed embodiments can facilitate determination of a set of underloaded sub-areas U, a set of overloaded sub-areas O, and a set of equilibrium sub-areas E.

If a single service provider is transferred from any sub-area aₖ in zone U (e.g., the underloaded sub-areas 212 of FIG. 2) to any sub-area aₘ in zone O (e.g., the overloaded sub-areas (214) in FIG. 2, then the objective will be improved. Thus, transfer of as many as possible service providers from zone U to zone O should occur. In this way, the objective function (e.g., Formula 1) can be minimized and the required global minimum can be determined without using any optimization processes.

It is noted that based on Formula 4, the equilibrium condition includes average ratio of work hours per service provider

$$\frac{{S}_{t}}{{S}_{p}}$$

for service area A. This means that after optimization in most of the sub-areas the ratio

$$\frac{{t}_{i}}{{p}_{i}}$$

will be closer to the average ratio

$$\frac{{S}_{t}}{{S}_{p}} .$$

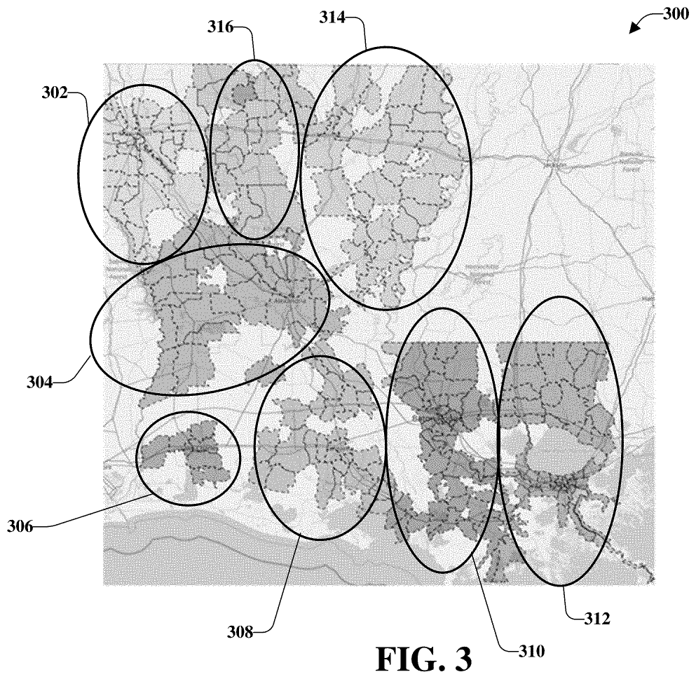

FIG. 3 illustrates an example, non-limiting, representation of an implementation that uses geographic locations of a geographic map 300 for equalizing resources associated with customer service in a telecom industry in accordance with one or more embodiments described herein. The geographic map 300 represents service Area A, which is divided into a set of routing areas (RA), which are generally identified by the circled areas 302 through 316 on the geographic map 300. Each RA has a garage, and several technicians assigned to the RA. The number of technicians can be from 2 to 70, for example, depending on the RA size and potential number of customer service requests per day.

For purposes of explaining FIG. 3, service A can also be referred to as the AOI (Area of Interest), Service Sub-area aᵢ can also be referred to as Routing Area aᵢ. Service Requestor rᵢ can also be referred to as Customer rᵢ. Further, Service Provider pᵢ can also be referred to as Technician pᵢ and Service Duration tᵢ can also be referred to as Duration tᵢ.

The Service Duration tᵢ is estimated based on historical data and the number of customers with scheduled service appointments for a particular day. The job duration should be predicted or determined before the load balancer embodiments discussed herein are applied. The prediction can be based on historical information, inferred information, or other information that estimates the amount of time necessary to perform the particular job. The prediction should be performed before application of the load balancing as discussed herein because when a workday is planned, the actual durations are not known (e.g., can take longer or shorter than predicted). However, the average job duration over a long enough historical period can be used to obtain a more accurate prediction. As an option, job duration predicted via predictive modeling techniques can be utilized. In order to apply load balancer embodiments as discussed herein, the total number of required work hours for each routing area is needed.

The demand is different for each day and determined by the number of customer calls requesting service (e.g., installation, repair, and so on) in each service sub-area aᵢ. In order to apply the load balancer embodiments the total number of required work hours for each routing area is needed.

The supply is determined by the number of technicians pᵢ assigned to each routing area (RA), and available for performing service at a particular date. It is different for each day pᵢ, and depends on day of week, holiday schedule, vacations, and so forth.

Customer service in the telecom industry requires performing hundreds and even thousands of different types of jobs, which in turn requires the availability of technicians with different skill sets (e.g., a constraint). In this case, the load balancer embodiments should be applied to each skill set separately. For example, if there are technicians with skill set A and skill set B, technicians A can be moved around to minimize disbalance between demand and supply, and then minimize disbalance for technicians B. This approach simplifies the task dramatically and does not introduce any additional error.

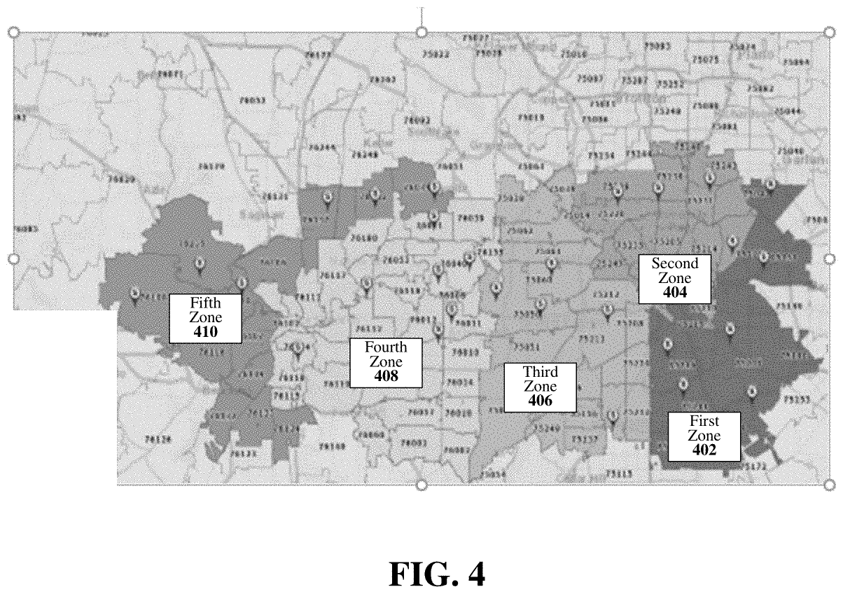

FIG. 4 illustrates an example, non-limiting, representation of an implementation that uses a geographic map 400 for facilitating delivery of items in accordance with one or more embodiments described herein. According to some implementations, the items can be related to deliveries associated with the postal service industry (e.g., United States Postal Service (USPS®), United Parcel Service® (UPS®), Federal Express® (FedEx®), and so on).

Territory A is divided into a set of zones represented by the different shading, and generally identified as a first zone 402, a second zone 404, a third zone 406, a fourth zone 408, and a fifth zone 410. Each zone has a garage, a central post office, and several postmen assigned to the zone. Each zone covers several zip codes. The number of postmen depends on zone size and potential number of mail items to be delivered per day.

For purposes of explaining FIG. 4, Service Area A can also be referred to as the territory and Service Sub-area aᵢ can also be referred to as Zone aᵢ. Further Service Requestor rᵢ can also be referred to as Customer rᵢ. Service Provider pᵢ can also be referred to as Postman pᵢ and Service Duration tᵢ can also be referred to as Duration tᵢ.

The demand is different for each day and determined by the number of parcels and letters that need to be delivered to customers in each zone aᵢ. The supply is determined by the number of postmen pᵢ assigned to each zone, and available for performing post delivery service at a particular date. It is different for each day pᵢ, and depends on day of week, holiday schedule, vacations, etc.

Service Duration tᵢ is estimated based on historical data and the number of parcels/letters which need to be delivered to customers for a particular day. In order to apply the load balancer embodiments discussed herein, the total number of required work hours for each zone is needed in advance.

Every day each post office prepares mail items to be delivered, and estimates the total time required to deliver all mail items in each particular zone. The actual number of postmen available to perform delivery for tomorrow is also available. The load balancer embodiments provided herein allow for the identification of overloaded zones and underloaded zones, and generates a plan of how to move postmen from underloaded zones to overloaded zones in order to minimize disbalance between demand and supply.

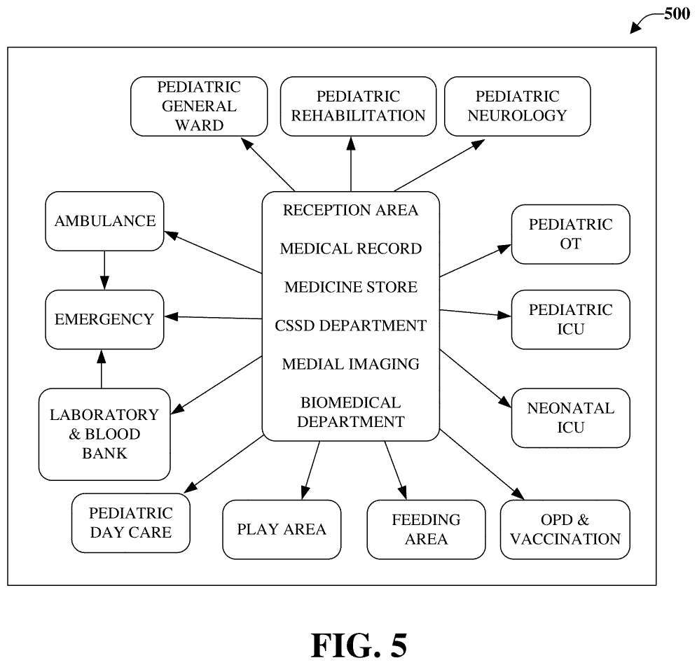

FIG. 5 illustrates an example, non-limiting, schematic representation 500 for an implementation for rostering nurses in a hospital in accordance with one or more embodiments described herein. For example, hospital A is divided into a set of hospital departments. Each hospital department has several nurses assigned to the department. Basically, the number of nurses in each department depends on the department size. Also, the number of nurses in each department depends on day of week, holiday schedule, vacations, and so on.

For purposes of explaining FIG. 5, Service Area A can also be referred to as the hospital and Service Sub-area aᵢ can also be referred to as Department aᵢ. Further Service Requestor rᵢ can also be referred to as Patient rᵢ. Service Provider pᵢ can also be referred to as Nurse pᵢ and Service Duration tᵢ can also be referred to as Duration tᵢ.

The demand is different for each day and determined by the number of patients that need to be treated in each hospital department aᵢ and on the treatment plan prescribed by doctors for each patient. The supply is determined by the number of nurses pᵢ assigned to each department, and available for performing all necessary medical treatments at a particular date. The supply is different for each day pᵢ, and depends on day of week, holiday schedule, vacations, and so forth.

Service Duration tᵢ is estimated based on historical data and the number of patients in a hospital department with a certain number of medical procedures prescribed to each patient. In order to apply the load balancer embodiments, the total number of required work hours for each department is needed in advanced. The required work hours can be based on historical data associated with each medical procedure. The load balancer embodiments facilitate the identification of overloaded and underloaded departments and generates an optimal plan how to move nurses from underloaded to overloaded departments in order to minimize disbalance between demand and supply.

Staff rostering is a common task in many industries such as health industry, airlines, hospitality industry, and others. Thousands of companies use rostering software to manage millions of employees in the world. Employee scheduling software automates the process of creating and maintaining a schedule. Automating the scheduling of employees increases productivity and allows organizations with hourly workforces to re-allocate resources to non-scheduling activities. Such software will usually track vacation time, sick time, compensation time, and alert when there are conflicts.

Existing software automated rostering solutions are based on optimization algorithms such as stochastic optimization, genetic algorithms, colony optimization, simulated annealing, quantum annealing Tabu search, and coordinate descent. Such optimization tasks have NP-hard complexity.

The load balancer embodiments provided here is an alternative to optimization process approaches, which allows the disclosed embodiments to avoid using optimization at all. Further, the disclosed embodiments are faster by orders of magnitude (as compared to rostering optimization processes) because the disclosed embodiments do not use resource consuming optimization techniques. Additionally, the disclosed embodiments are more accurate as compared to rostering optimization processes) because the disclosed embodiments determines a global optimum solution, and as result, never uses local optima which is typical for optimization algorithms.

Further, the load balancer embodiments as discussed herein are based on the equilibrium condition (e.g., Formula 4), which includes the number of service providers pᵢ (supply) and the number of work hours tᵢ necessary to perform required work (demand). The number of service providers pᵢ is actual information available each morning. The number of work hours tᵢ is unknown because the job is not completed yet, and it is not known how long the job will actually take. However, tᵢ values are needed in order to balance demand and supply. Therefore, predicted tᵢ values based on historical information are utilized.

The manner of predicting tᵢ values can be different for each use case. For example, in the technical support use case scenario there are a number of service requests from customers such as installations, repairs, and so forth. Each type of service has its own average time estimation, which allows for taking into account each customer request, and summarizing required service time for each service sub-area.

For the hospital scenario there are a number of patients, and each patient has a list of medical procedures to be performed. Each medical procedure has a time required to perform the procedure. This allows for summarization of hours similar to the technical support scenario. For an airline scenario there are pilots pᵢ and flight durations, which similarly allows for the prediction of tᵢ. For the airline scenario the disclosed embodiments can also apply to the crew member, the airplanes themselves, and so on.

It is noted that the task considered with the disclosed embodiments belongs to the class of assignment problems, which is a fundamental combinatorial optimization problem. In its most general form, the problem is as follows: The problem instance has a number of agents and a number of tasks. Any agent can be assigned to perform any task, incurring some cost that may vary depending on the agent-task assignment.

The task is simplified with the disclosed embodiments because all the agents already have an initial assignment, and the assignments just need to be changed in such a way that disbalance between demand and supply would be minimized. However, even in such a simplified form, a combinatorial task that requires at least polynomial in n time to be solved is needed, which is a significant computational effort.

The disclosed embodiments do not use any optimization technique because it determines optimal solution analytically. Based on Formulas 1 to 9, the disclosed load balancer determines overloaded and underloaded sub-areas, and moves service providers from underloaded to overloaded areas.

Advantages of the disclosed embodiments is that the load balancer finds more accurate solutions (as compared to existing processes) because the disclosed load balancer determines a global optimal solution analytically, and as result, never uses local optimal solutions, which is typical for combinatorial optimization algorithms. Another advantage is that the disclosed load balancer calculates the required result hundreds of times faster as compared to existing combinatorial optimization algorithms.

Accordingly, the disclosed embodiments provide an approach to solve the optimization problem in two steps. First, a set of service sub-areas are split into three subsets based on Formulas 1 to 9: underloaded, overloaded, and equilibrium. Next, service providers are moved from underloaded sub-areas to overloaded sub-areas to reduce disbalance between demand and supply.

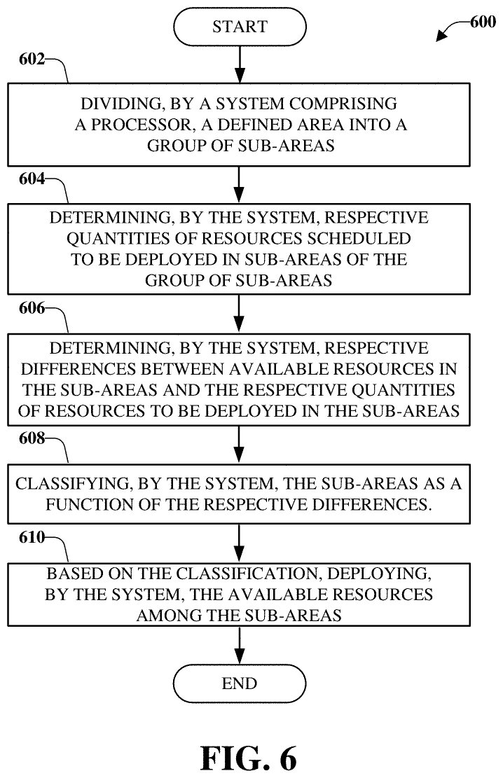

FIG. 6 illustrates an example, non-limiting, computer-implemented method 600 for facilitating achievement of equilibrium between supply and demand of resources in accordance with one or more embodiments described herein. The computer-implemented method 600 can be implemented by a system including a processor, network equipment including a processor, or another computer-implemented device including a processor.

The computer-implemented method 600 starts at 602 with dividing a defined area into a group of sub-areas. The defined area can be a geographic area or other area of interest (e.g., territory, hospital, and so forth). The group of sub-areas are smaller portions of the defined area. For example, the group of sub-areas can be routing areas, zones, departments, and so on.

At 604, respective quantities of resources scheduled to be deployed in sub-areas of the group of sub-areas is determined. The determination can be based on received requests. Thus, for each sub-area there can be a quantity of requests and a determination is made as to how many resources are needed to service the requests. Further, there can be a certain number of resources scheduled (e.g., available) for each sub-area. Thus, at 606, respective differences between available resources in the sub-areas and the respective quantities of resources to be deployed in the sub-areas is determined.

The sub-areas can be classified, at 608, as a function of the respective differences. For example, the sub-areas can be classified into respective groups of sub-areas. The respective groups comprise three groups or subsets: a first subset comprising an underloaded condition, a second subset comprising an overloaded condition, and a third subset comprising an equilibrium condition. For example, if a sub-area has less resources available than the number of resources needed, that area can be classified as being in the overloaded condition. In another example, if a sub-area has more resources available than the number of resources needed, that sub-area can be classified as being in the underloaded condition. According to another example, if a sub-area has an equal, or nearly equal, number of resources available as the number of resources needed, the sub-area can be classified as being in the equilibrium condition.

Based on the classification, at 610, the available resources are deployed among the sub-areas. For example, a first sub-area is classified as being in the underloaded condition, and a second sub-area is classified as being in the overloaded condition, thus, the deploying at 610 includes moving a resource (or more than one resource) from the first sub-area to the second sub-area. According to some implementations, moving of the one or more resources can include reducing an imbalance between the received requests and the respective quantities of resources scheduled to be deployed in the sub-areas. In another example, a sub-area that is classified as being in the equilibrium condition is marked as unchangeable (e.g., no resources are removed and no resources are added).

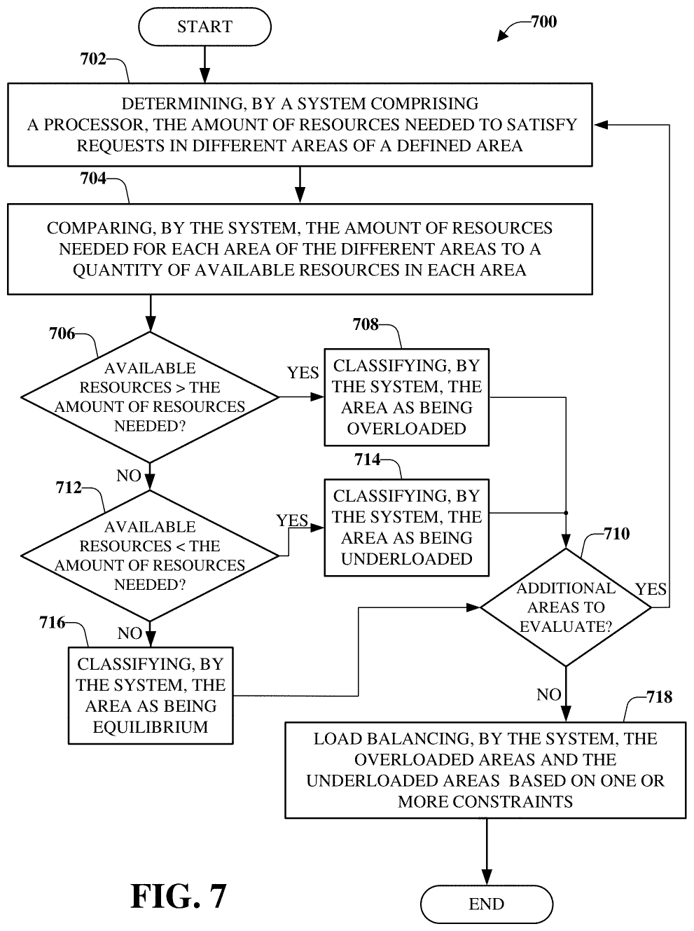

FIG. 7 illustrates an example, non-limiting, computer-implemented method 700 for load balancing resources in accordance with one or more embodiments described herein. The computer-implemented method 700 can be implemented by a system including a processor, network equipment including a processor, or another computer-implemented device including a processor.

At 702, the amount of resources needed to satisfy requests in different areas of a defined area are determined. The request can be related to predictable tasks to be performed, or unpredictable tasks to be performed. Determination of the amount of resources needed can be based on historical information collected over time. Further, the determination can be based on the amount of time (duration) during which the requests for the resources should be satisfied.

At 704, the amount of resources needed for each area of the different areas is compared to a quantity of available resources in each area. For example, each area can have a certain number of resources already allocated to the area.

A determination is made, at 706, whether the available resources are more than the amount of resources needed. If so, the area is classified as being in the underloaded condition, at 708. The computer-implemented method 700 determines, at 710, whether there are more sub-areas that have not been classified. If so (“YES”), the computer-implemented method 700 returns to 702 and a subsequent area is analyzed, until no further areas remain.

If the determination at 708 is that the available resources are more than the amount of resources needed (“NO”), at 712, it is determined whether the available resources are less than the amount of resources needed. If so (“YES”), the area is classified as being in the overloaded condition, at 714 and, if there are more sub-areas to classify, as determined at 710, the computer-implemented method 700 returns to 702 and a subsequent area is analyzed, until no further areas remain. Otherwise, the available resources are equal (or nearly equal) to the amount of resources needed and the area is classified, at 716, as being in the equilibrium condition and the area is marked as being unchangeable (e.g., no resources should be added; no resources should be removed). Then, another determination is made, at 710, whether there are any other sub-areas to be classified and, if so, the computer-implemented method 700 returns to 702 and a subsequent area is analyzed, until no further areas remain.

Upon or after all areas have been classified (e.g., when the determination at 710 is “NO”), at 718, the resources between the areas being in the underload condition and the areas being in the overload condition are balanced. The load balancing can consider various constraints related to the resources and/or the requests. The one or more constraints include, but are not limited to: travel time, qualifications, duration during which the requests should be fulfilled, and so on. The constraints can be utilized to determine if resources can be moved between areas, and which resources should be moved, at least temporarily.

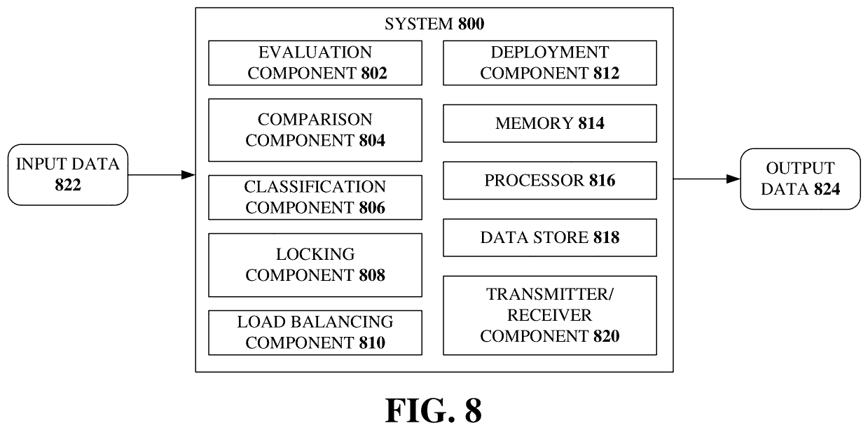

FIG. 8 illustrates an example, non-limiting, system 800 that facilitates achieving stable equilibrium between supply and demand of resources in accordance with one or more embodiments described herein. Repetitive description of like elements employed in other embodiments described herein is omitted for sake of brevity. The system 800 can be configured to perform functions associated with the computer-implemented method 100 of FIG. 1, the computer-implemented method 600 of FIG. 6, the computer-implemented method 700 of FIG. 7, and/or other computer-implemented methods discussed herein.

Aspects of systems (e.g., the system 800 and the like), apparatuses, and/or processes (e.g., computer-implemented methods) explained in this disclosure can include machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described. In various embodiments, the system 800 can be any type of component, machine, device, facility, apparatus, and/or instrument that can include a processor and/or can be capable of effective and/or operative communication with a wired and/or wireless network.

The system 800 can include an evaluation component 802, a comparison component 804, a classification component 806, a locking component 808, a load balancing component 810, a deployment component 812, at least one memory 814, at least one processor 816, at least one data store 818, and a transmitter/receiver component 820. In various embodiments, one or more of: the evaluation component 802, the comparison component 804, the classification component 806, the locking component 808, the load balancing component 810, the deployment component 812, the at least one memory 814, the at least one processor 816, the at least one data store 818, and the transmitter/receiver component 820 can be electrically and/or communicatively coupled to one another to perform one or more of the functions of the system 800. In some embodiments, one or more of: the evaluation component 802, the comparison component 804, the classification component 806, the locking component 808, the load balancing component 810, the deployment component 812, and the transmitter/receiver component 820 can include software instructions stored on the at least one memory 814 and/or the at least one data store 818 and executed by the at least one processor 816. The system 800 may also interact with other hardware and/or software components not depicted in FIG. 8.

The evaluation component 802 can receive input data 822 (e.g., via the transmitter/receiver component 820). The input data 822 can include, but is not limited to, information related to the sub-areas of a defined area, constraints related to one or more resources in the sub-areas, requests for resources, historical information related to deployment of resources, and so on.

Based on the input data 822, the evaluation component 802 can determine a first amount of resources necessary to satisfy first requests in a first area, and a second amount of resources necessary to satisfy second requests in a second area. Further, the evaluation component 802 can determine subsequent amounts of resources that are to satisfy subsequent requests in subsequent areas. The first area, the second area, and the subsequent areas are portions of a defined area, which have been divided into smaller areas.

The comparison component 804 can compare the first amount of resources necessary to satisfy the first requests with a first quantity of available resources in the first area, and the second amount of resources necessary to satisfy the second requests with a second quantity of available resources in the second area. Further, the comparison component 804 can compare the subsequent amount of resources necessary to satisfy the subsequent requests of each subsequent area with subsequent quantities of available resources in the subsequent areas.

Based on the comparison performed by the comparison component 804, each area (e.g., the first area, the second area, the subsequent area(s)) are classified, by the classification component 806 into one classification of a group of three classifications. The three classifications include an overload classification (e.g., overloaded condition), an underloaded classification (e.g., underloaded condition), and an equilibrium classification (e.g., equilibrium condition).

For example, based on the first quantity of available resources being determined to be less than the first amount of resources necessary to satisfy the first requests, the classification component 806 classifies the first area as being in an overloaded condition. Further, based on the second quantity of available resources being determined to be more than the second amount of resources necessary to satisfy the second requests, the classification component 806 classifies the second area as being in an underloaded condition.

If the quality of available resources and the amount of resources needed to satisfy the requests are nearly the same (e.g., within a defined value of one another), the area is classified, by the classification component 806, as being in the equilibrium condition. In this case, the locking component 808 identifies the resources in the area as being unchangeable (e.g., the resources are not moved to load balance other areas). The identification as being unchangeable can be temporary, depending on the time frame under consideration for satisfying the requests.

Further, based on the classification, the load balancing component 810 moves at least one resource from an area identified as being in an underloaded condition to another area that is identified as being in the overloaded condition. According to some implementations, the load balancing component 810 can determine movement of the resources among the areas based on one or more constraints associated with the resources. For example, a constraint can be a distance between a current location of a resource to a location of where the resource is to be deployed. Another constraint is the availability of the resource (e.g., work hours, maintenance schedule, power-off hours, and so on).

The deployment component 812 can deploy (or facilitate deployment) of the resources among the areas. For example, the deployment component 812 can output instructions related to the allocation of resources after the load balancing. For example, the deployment component 812 can provide a scheduling order of the resources that instructs a resource as to the scheduling order that should be utilized to service the requests. A result of the allocation by the load balancing component 810 and/or the deployment component 812 can be output, as output data 824 in any computer-readable format and/or perceivable format.

The at least one memory 814 can be operatively connected to the at least one processor 816. The at least one memory 814 and/or the at least one data store 818 can store executable instructions that, when executed by the at least one processor 816 can facilitate performance of operations. Further, the at least one processor 816 can be utilized to execute computer executable components stored in the at least one memory 814 and/or the at least one data store 818.

For example, the at least one memory 814 can store protocols associated with evaluating, comparing, classifying, locking, balancing, deploying, receiving data, and outputting data as discussed herein. Further, the at least one memory 814 can facilitate action to control communication between the system 800, other apparatuses, other systems, network equipment, and/or user equipment associated with the categories under consideration, and so on, such that the system 800 can employ stored protocols and/or processes to facilitate load balancing of resources as described herein.

It should be appreciated that data stores (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically Programmable ROM (EPROM), Electrically Erasable ROM (EEPROM), or flash memory. Volatile memory can include Random Access Memory (RAM), which acts as external cache memory. By way of example and not limitation, RAM is available in many forms such as Synchronous RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DRRAM). Memory of the disclosed aspects are intended to include, without being limited to, these and other suitable types of memory.

The at least one processor 816 can facilitate respective analysis of deployment of resources as discussed herein. The at least one processor 816 can be a processor dedicated to analyzing and/or generating information received, a processor that controls one or more components of the system 800, and/or a processor that both analyzes and generates information received and controls one or more components of the system 800.

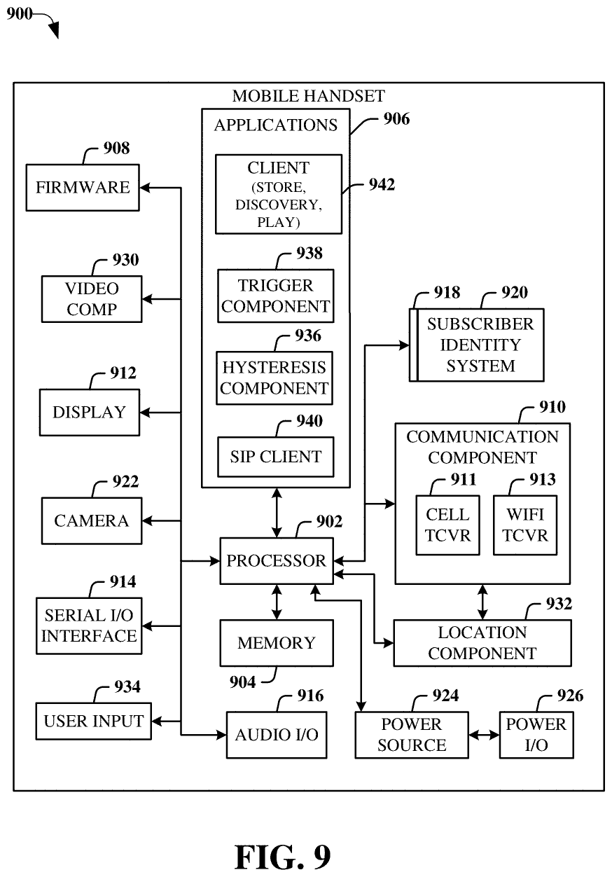

Described herein are systems, methods, articles of manufacture, non-transitory machine-readable medium, and other embodiments or implementations that can facilitate achievement of equilibrium between supply and demand of resources. Referring now to FIG. 9, illustrated is an example, non-limiting, block diagram of a handset 900 operable to engage in a system architecture that facilitates wireless communications according to one or more embodiments described herein. Although a mobile handset is illustrated herein, it will be understood that other devices can be a mobile device, and that the mobile handset is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information, and which can be accessed by the computer.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset includes a processor 902 for controlling and processing all onboard operations and functions. A memory 904 interfaces to the processor 902 for storage of data and one or more applications 906 (e.g., a video player software, user feedback component software, etc.). Other applications can include voice recognition of predetermined voice commands that facilitate initiation of the user feedback signals. The applications 906 can be stored in the memory 904 and/or in a firmware 908, and executed by the processor 902 from either or both the memory 904 or/and the firmware 908. The firmware 908 can also store startup code for execution in initializing the handset 900. A communications component 910 interfaces to the processor 902 to facilitate wired/wireless communication with external systems, e.g., cellular networks, VoIP networks, and so on. Here, the communications component 910 can also include a suitable cellular transceiver 911 (e.g., a GSM transceiver) and/or an unlicensed transceiver 913 (e.g., Wi-Fi, WiMax) for corresponding signal communications. The handset 900 can be a device such as a cellular telephone, a PDA with mobile communications capabilities, and messaging-centric devices. The communications component 910 also facilitates communications reception from terrestrial radio networks (e.g., broadcast), digital satellite radio networks, and Internet-based radio services networks.

The handset 900 includes a display 912 for displaying text, images, video, telephony functions (e.g., a Caller ID function), setup functions, and for user input. For example, the display 912 can also be referred to as a “screen” that can accommodate the presentation of multimedia content (e.g., music metadata, messages, wallpaper, graphics, etc.). The display 912 can also display videos and can facilitate the generation, editing and sharing of video quotes. A serial I/O interface 914 is provided in communication with the processor 902 to facilitate wired and/or wireless serial communications (e.g., USB, and/or IEEE 1394) through a hardwire connection, and other serial input devices (e.g., a keyboard, keypad, and mouse). This can support updating and troubleshooting the handset 900, for example. Audio capabilities are provided with an audio I/O component 916, which can include a speaker for the output of audio signals related to, for example, indication that the user pressed the proper key or key combination to initiate the user feedback signal. The audio I/O component 916 also facilitates the input of audio signals through a microphone to record data and/or telephony voice data, and for inputting voice signals for telephone conversations.

The handset 900 can include a slot interface 918 for accommodating a SIC (Subscriber Identity Component) in the form factor of a card Subscriber Identity Module (SIM) or universal SIM 920, and interfacing the SIM card 920 with the processor 902. However, it is to be appreciated that the SIM card 920 can be manufactured into the handset 900, and updated by downloading data and software.

The handset 900 can process IP data traffic through the communications component 910 to accommodate IP traffic from an IP network such as, for example, the Internet, a corporate intranet, a home network, a person area network, etc., through an ISP or broadband cable provider. Thus, VoIP traffic can be utilized by the handset 900 and IP-based multimedia content can be received in either an encoded or decoded format.

A video processing component 922 (e.g., a camera) can be provided for decoding encoded multimedia content. The video processing component 922 can aid in facilitating the generation, editing, and sharing of video quotes. The handset 900 also includes a power source 924 in the form of batteries and/or an AC power subsystem, which power source 924 can interface to an external power system or charging equipment (not shown) by a power I/O component 926.

The handset 900 can also include a video component 930 for processing video content received and, for recording and transmitting video content. For example, the video component 930 can facilitate the generation, editing and sharing of video quotes. A location tracking component 932 facilitates geographically locating the handset 900. As described hereinabove, this can occur when the user initiates the feedback signal automatically or manually. A user input component 934 facilitates the user initiating the quality feedback signal. The user input component 934 can also facilitate the generation, editing and sharing of video quotes. The user input component 934 can include such conventional input device technologies such as a keypad, keyboard, mouse, stylus pen, and/or touchscreen, for example.

Referring again to the applications 906, a hysteresis component 936 facilitates the analysis and processing of hysteresis data, which is utilized to determine when to associate with the access point. A software trigger component 938 can be provided that facilitates triggering of the hysteresis component 936 when the Wi-Fi transceiver 913 detects the beacon of the access point. A SIP client 940 enables the handset 900 to support SIP protocols and register the subscriber with the SIP registrar server. The applications 906 can also include a client 942 that provides at least the capability of discovery, play and store of multimedia content, for example, music.

The handset 900, as indicated above related to the communications component 910, includes an indoor network radio transceiver 913 (e.g., Wi-Fi transceiver). This function supports the indoor radio link, such as IEEE 802.11, for a dual-mode GSM handset. The handset 900 can accommodate at least satellite radio services through a handset that can combine wireless voice and digital radio chipsets into a single handheld device.

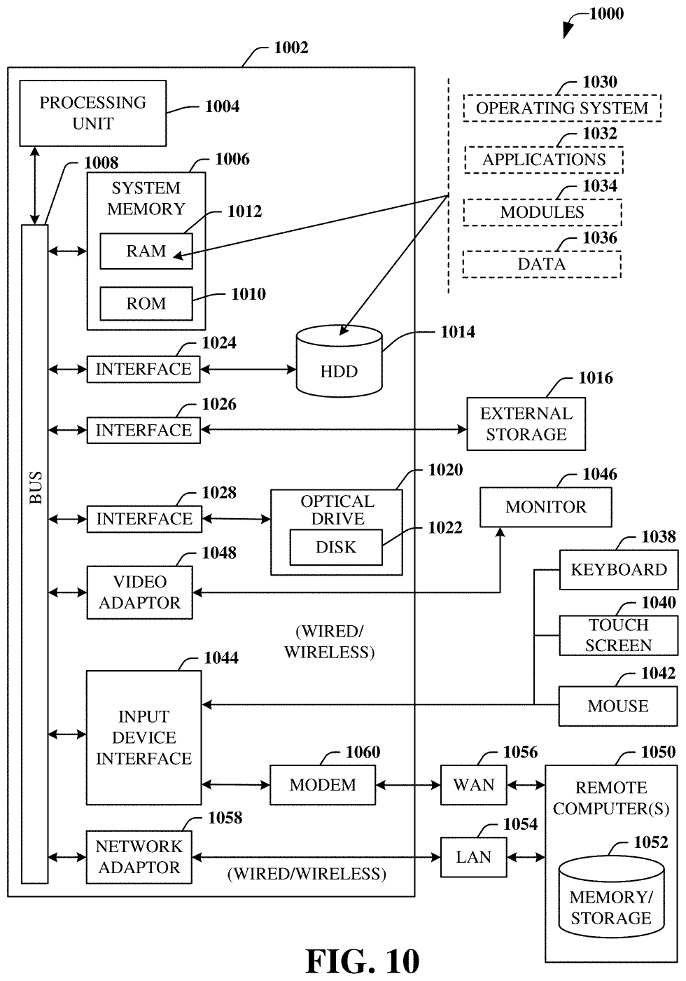

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A Basic Input/Output System (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and a drive 1020, e.g., such as a solid state drive, an optical disk drive, which can read or write from a disk 1022, such as a CD-ROM disc, a DVD, a BD, etc. Alternatively, where a solid state drive is involved, disk 1022 would not be included, unless separate. While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and drive 1020 can be connected to the system bus 1008 by an HDD interface 1024, an external storage interface 1026 and a drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally include emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can include one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For example, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above, such as but not limited to a network virtual machine providing one or more aspects of storage or processing of information. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

An aspect of 5G, which differentiates from previous 4G systems, is the use of NR. NR architecture can be designed to support multiple deployment cases for independent configuration of resources used for RACH procedures. Since the NR can provide additional services than those provided by LTE, efficiencies can be generated by leveraging the pros and cons of LTE and NR to facilitate the interplay between LTE and NR, as discussed herein.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments.

As used in this disclosure, in some embodiments, the terms “component,” “system,” “interface,” and the like are intended to refer to, or can include a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device,” “user equipment” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, including, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z-Wave, Zigbee and other 802.XX wireless technologies and/or legacy telecommunication technologies.

The various aspects described herein can relate to New Radio (NR), which can be deployed as a standalone radio access technology or as a non-standalone radio access technology assisted by another radio access technology, such as Long Term Evolution (LTE), for example. It should be noted that although various aspects and embodiments have been described herein in the context of 5G, Universal Mobile Telecommunications System (UMTS), and/or Long Term Evolution (LTE), or other next generation networks, the disclosed aspects are not limited to 5G, 6G, a UMTS implementation, and/or an LTE implementation as the techniques can also be applied in 3G, 4G, or LTE systems. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies.

As used herein, “5G” can also be referred to as NR access. Accordingly, systems, methods, and/or machine-readable storage media for facilitating link adaptation of downlink control channel for 5G systems are desired. As used herein, one or more aspects of a 5G network can include, but is not limited to, data rates of several tens of megabits per second (Mbps) supported for tens of thousands of users; at least one gigabit per second (Gbps) to be offered simultaneously to tens of users (e.g., tens of workers on the same office floor); several hundreds of thousands of simultaneous connections supported for massive sensor deployments; spectral efficiency significantly enhanced compared to 4G; improvement in coverage relative to 4G; signaling efficiency enhanced compared to 4G; and/or latency significantly reduced compared to LTE.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification procedures and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising;
dividing, by a system comprising a processor, a defined area into a group of sub-areas;
determining, by the system, respective quantities of resources scheduled to be deployed in sub-areas of the group of sub-areas based on received requests;
determining, by the system, respective differences between available resources in the sub-areas and the respective quantities of resources to be deployed in the sub-areas;
classifying, by the system, the sub-areas as a function of the respective differences; and
deploying, by the system, the available resources among the sub-areas based on the classifying.

2. The method of claim 1, wherein the classifying comprises respectively classifying respective sub-areas of the sub-areas as one of: a first subset comprising an underloaded condition, a second subset comprising an overloaded condition, and a third subset comprising an equilibrium condition.

3. The method of claim 2, wherein a first sub-area of the sub-areas is classified as being in the underloaded condition, wherein a second sub-area of the sub-areas is classified as being in the overloaded condition, and wherein the deploying comprises moving a resource from the first sub-area to the second sub-area.

4. The method of claim 3, wherein the moving of the resource comprises reducing an imbalance between the received requests and the respective quantities of resources scheduled to be deployed in the sub-areas.

5. The method of claim 2, wherein a third sub-area of the sub-areas is classified as being in the equilibrium condition, and wherein the method further comprises:
marking, by the system, the third subset in the equilibrium condition as unchangeable.

6. The method of claim 1, wherein the deploying comprises load balancing the available resources among the sub-areas.

7. The method of claim 1, further comprising:
prior to the determining of the respective differences, identifying, by the system, a defined time in which the received requests are to be satisfied.

8. The method of claim 1, further comprising:
determining, by the system, that a sub-area of the sub-areas has a higher quantity of resources scheduled to be deployed in the sub-area based on an analysis of the received requests; and
identifying, by the system, the sub-area as being in an underloaded condition.

9. The method of claim 1, further comprising:
determining, by the system, that a sub-area of the sub-areas has a lower quantity of resources scheduled to be deployed in the sub-area based on an analysis of the received requests; and
identifying, by the system, the sub-area as being in an overloaded condition.

10. The method of claim 1, further comprising:
prior to the determining of the respective quantities of resources, receiving, by the system, input data indicative of constraints related to respective availabilities of resources.

11. A system, comprising:
a processor; and
a memory that stores executable instructions that, when executed by the processor, facilitate performance of operations, comprising:
determining a first amount of resources that are to satisfy first requests in a first area, and a second amount of resources that are to satisfy second requests in a second area;
comparing the first amount of resources with a first quantity of available resources in the first area, and the second amount of resources with a second quantity of available resources in the second area; and
based on the first quantity of available resources being determined to be less than the first amount of resources and the second quantity of available resources being determined to be more than the second amount of resources:
classifying the first area as being in an overloaded condition,
classifying the second area as being in an underloaded condition, and
moving a resource of the second quantity of available resources to the first area.

12. The system of claim 11, wherein the operations further comprise:
based on the first quantity of available resources being more than the first amount of resources, and the second quantity of available resources being equal or nearly equal to the second amount of resources:
classifying the first area as being in the underloaded condition,
classifying the second area as being in an equilibrium condition, and
identifying the second quantity of available resources as unchangeable resources, wherein the first area remains classified as being in the underloaded condition.

13. The system of claim 11, wherein the moving of the resource comprises facilitating load balancing of resources between the first area and the second area, and wherein the resources comprise the first quantity of available resources and the second quantity of available resources.

14. The system of claim 11, wherein the operations further comprise:
prior to the determining of the first amount of resources, receiving input data that comprises first information indicative of the first area, second information indicative of the second area, third information indicative of an amount of resource requests, fourth information indicative of the first quantity of available resources in the first area, and fifth information indicative of the second quantity of available resources in the second area.

15. The system of claim 11, wherein the operations further comprise:
prior to the determining of the first amount of resources, receiving input data indicative of constraints related to the first quantity of available resources in the first area and the second quantity of available resources in the second area.

16. The system of claim 15, wherein the constraints are based on travel time between the first requests in the first area and the second requests in the second area.

17. A non-transitory machine-readable medium, comprising executable instructions that, when executed by a processor, facilitate performance of operations, comprising:
dividing a service area into three subsets of areas, wherein the three subsets of areas comprise a first subset as being in an underloaded condition, a second subset as being in an overloaded condition, and a third subset as being in an equilibrium condition;
adding first resources of the first subset to second resources of the second subset; and
retaining third resources of the third subset within the third subset.

18. The non-transitory machine-readable medium of claim 17, wherein the dividing comprises:
determining that first requests in the first subset are less than a first amount of first resources available in the first subset;
determining that second requests in the second subset are more than a second amount of second resources available in the second subset; and
determining third requests in the third subset are equal to a third amount of third resources available in the third subset.

19. The non-transitory machine-readable medium of claim 17, wherein the adding comprises:
initiating a load balancing of resources in the first subset and the second subset.

20. The non-transitory machine-readable medium of claim 17, wherein the adding comprises:
reclassifying the first subset and the second subset as being in the equilibrium condition.
